(19) United States
(12) Patent Application Publication
(10) Pub. No.: US 2019/0177912 A1
(43) Pub. Date: Jun. 13, 2019

(54) METHOD AND SYSTEM FOR PLASMA TREATMENT

(71) Applicant: NIKE, Inc., Beaverton, OR (US)

(72) Inventors: Damian Marsden, Taichung (TW); Christos Fotios Karanikas, Taichung (TW)

(21) Appl. No.: 16/218,205

(22) Filed: Dec. 12, 2018

Related U.S. Application Data
(60) Provisional application No. 62/598,400, filed on Dec. 13, 2017.

(51) Int. Cl. D06N 3/00; B05C 5/02; B05C 11/02; C09J 5/02

(52) U.S. Cl. CPC D06N 3/0081; B05C 5/02; B05C 11/023; C09J 5/02; D10B 2501/043; D06N 2203/068; D06N 2207/14; D06N 2211/106; D06N 3/0056

(57) ABSTRACT

A method for treating a natural or synthetic leather object is provided. The method includes directing plasma onto a surface of an natural or synthetic object to form a plasma treated object, the object including at least one of a natural leather material and a synthetic leather material, applying adhesive onto the plasma treated object, and bonding the plasma treated object with a polymeric coating.

### CROSS REFERENCE TO RELATED APPLICATIONS

The present application claims priority to U.S. Provisional Patent Application No. 62/598,400, entitled “METHOD AND SYSTEM FOR PLASMA TREATMENT”, filed on Dec. 13, 2017. The entire contents of the above-listed application are incorporated herein by reference for all purposes.

### FIELD

The present description relates generally to systems and methods for treating objects with plasma.

### BACKGROUND/SUMMARY

Products utilizing synthetic and natural leather may be treated with a surface coating to protect the leather. For instance, polymeric materials such as polyurethane (PU) have been used as a surface treatment in leather footwear. The physical and mechanical properties of prior leather goods treated with a polymeric coating, however, have fallen short of design goals. For instance, leather products having a polymeric coating have previously had less than desired ply adhesion between the leather and the surface coating, reduced abrasion resistance, reduced tear strength, reduced break/pipiness (e.g., increased wrinkling), etc., resulting in decreased durability and ultimately reduced product longevity.

The inventors herein have recognized the above issues, and thus have developed one or more approaches to address at least some of these issues. In one approach, a method for treating a natural or synthetic leather object is provided. The method includes treating a natural or synthetic leather object with plasma from a plasma source and adhesively bonding a polymeric coating to the object. Treating the leather object with the plasma may improve the object's physical properties and manufacturability. In one example, treating the natural or synthetic leather object with plasma increases the ply adhesion between the leather and the polymeric coating, the object's abrasion resistance, the tear strength of the object, and the break/pipiness of the object.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic depiction of a plasma treatment system.

FIGS. 2-4 show a plasma treatment sequence for an object using the plasma treatment system, shown in FIG. 1.

FIG. 5 shows an exploded view of an article of footwear including an object treated with plasma.

FIG. 6 shows a cross-section of the article of footwear, shown in FIG. 5, in an assembled state.

FIG. 7 shows a method for treating an object with a plasma.

FIG. 8 shows a use-case example of a leather treatment process.

### DETAILED DESCRIPTION

Products, such as articles of footwear, may include sections constructed from natural and/or synthetic leather coated with polyurethane (PU) or other polymeric materials. The polymeric coatings may at least partially serve to protect the object against water penetration, provide some abrasion resistance, and enhance the object's appearance. Nonetheless, polymer coated objects may have some undesirable physical properties and manufacturing challenges. For instance, the polymeric coating may be poorly bonded with the natural or synthetic leather, due to impurities in and/or on the leather. The weak bond between the polymeric coating and the leather decreases the object's durability and ultimately reduces the lifespan of the article of footwear or other goods having the object incorporated therein. Other problems with prior polymer coated leather goods include low tear resistance, low break/pipiness, etc. Specifically in one example, the weakly bonded polymeric coating may interfere with the adhesion between the leather and other portions of the product (e.g., article of footwear), such as a sole. The weak bond between the polymeric coating and the leather may result in additional manufacturing steps such as buffing sections of the object to remove or otherwise modify the polymeric coating. However, buffing may create additional or exacerbate existing issues such as increased manufacturing complexity and costs. Moreover, buffing can also cause unwanted abrasive wear to the product in some cases, particularly when the product includes recycled leather fibers. The low tear resistance may also necessitate more reinforcement to be added to vulnerable sections of the product such a crease lines, high wear areas, etc.

In one embodiment, to at least partially improve the physical properties and manufacturability of synthetic and/or natural leather goods, various methods and systems for plasma treatment are provided. In one example, a method for treating a natural or synthetic leather object is provided. The method includes directing plasma onto a surface of an object to form a plasma treated object, the object including at least one of a natural leather material and a synthetic leather material. The method also includes bonding the plasma treated object with a polymeric coating after a layer of adhesive is applied to the object. Treating the object with plasma increases the ply adhesion between the polymeric coating and the object. Other benefits of the plasma treatment include increased resistance against tears and abrasions, and improved break/pipiness of the object that are particularly relevant to improving the manufacturing efficiency of footwear. While one use-case example of the plasma treated object described herein relates to an article of footwear, the plasma treatment techniques may be applied to a variety of objects having natural and/or synthetic leather. The objects may include sporting equipment (e.g., balls, gloves, etc.,), upholstered furniture, automotive upholstery, fashion goods (e.g., handbags, wallets, etc.,), clothing, etc. As such, the plasma treatment process may have wide applicability across a range of manufactured goods, products, etc. Further in one example, a step of buffing the polymeric coating in the object may be reduced or completely omitted in a manufacturing process in which the object is utilized due to the increased bonding strength between the polymeric coating and the object. As a result, manufacturing costs of the object are reduced. The increased tear strength of the object may also enable an article of footwear or other product in which the object is incorporated to reduce reinforcing materials used in the product. Consequently, the manufacturing costs of the article of footwear or other product incorporating the plasma treated object can be further reduced.

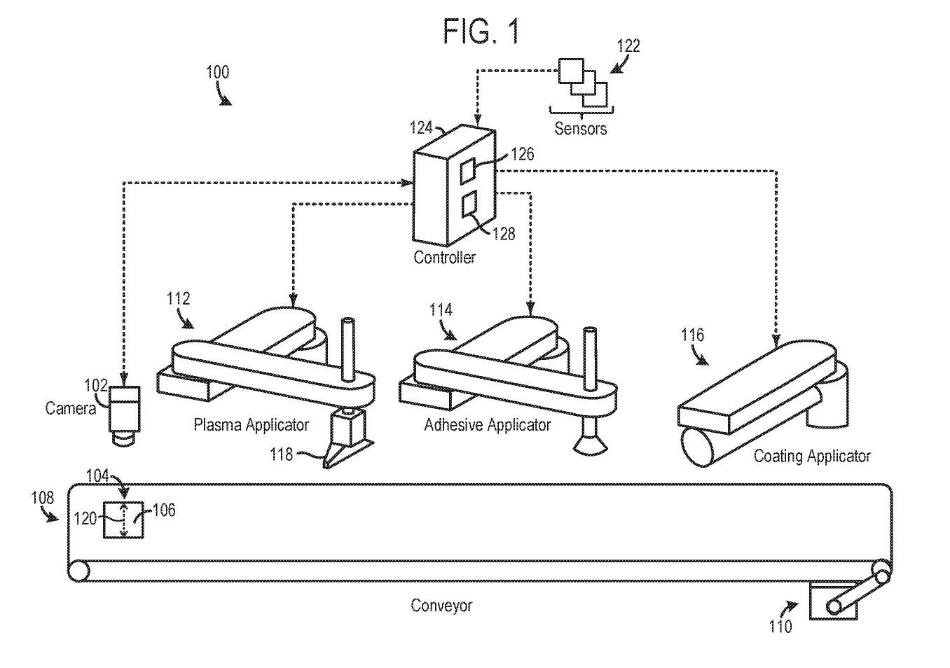

FIG. 1 illustrates a plasma treatment system 100. The plasma treatment system 100 includes a camera 102 designed to capture images of an object 104. In the depicted example, the object has a flat shape with a planar upper surface 106. However, it will be appreciated that the flat object may be processed via downstream manufacturing steps to form an article of footwear, sporting good, fashion good, etc. Yet, the plasma treatment system 100 may also be used to treat three-dimensional objects such as objects at later stages in a manufacturing process when they have three-dimensional contours. In such an example, the camera 102 may be designed to capture vision data that enables the object's contour to be three-dimensionally mapped. The object 104 includes natural and/or synthetic leather. As described herein natural leather includes any tanned animal rawhide or skin. It will be appreciated that natural leather may include recycled leather fibers. When the object includes recycled leather the environmental footprint of the object and the consumer good having the object incorporated therein is reduced. Additionally, synthetic leather encompasses any fabric that has been treated to have an appearance, finish, etc., that resembles leather including but not limited to poromeric imitation leathers, cork leathers, leatherette, synthetic microfibers, etc.

The object 104 is shown positioned on a conveyor 108 designed to move the object 104 in a desired path during the plasma treatment process. The conveyor 108 includes a drive device 110 facilitating movement of the object along the desired path. Additionally or alternatively mechanical arms (e.g., robotic arms), carriages, workers, etc., may be used to move the object through the plasma treatment process, in other examples.

The plasma treatment system 100 additionally includes a plasma applicator 112, an adhesive applicator 114, and a coating applicator 116. In other examples, the adhesive applicator 114 and/or the coating applicator 116 may be omitted from the plasma treatment system 100. In further examples, the applicators may take other forms such as a single applicator that houses a plasma treatment device, an adhesive device, and/or a coating device.

The plasma applicator 112 is designed to apply plasma onto an exposed surface of the object 104. Plasma is an ionized gas and is one of the four common states of matter. In particular, plasma is an ionized gas with positive ions and free electrons that are proportioned to allow the gas to have substantially no overall electric charge. It will also be appreciated that plasma may be applied in both a thermal form and a non-thermal form. Thermal plasmas have electrons and other particles at thermal equilibrium while non-thermal plasmas do not exhibit thermal equilibrium. In one example, the plasma applicator may use a multi-gas composition (e.g., atmospheric air) to form the plasma. For instance, plasma may be an atmospheric pressure plasma. In such an example, the plasma applicator 112 may include an anode and a cathode generating a high voltage there between to create plasma. However, in other examples the plasma may be a vacuum plasma. In such an example, a plasma source may take the place of the plasma applicator in the plasma treatment system. In yet other examples, alternate plasma generation devices and techniques have been contemplated such as corona treatment devices, flame plasma devices, chemical plasma devices, etc. Thus in other examples, the plasma applicator or plasma source may be a corona treatment apparatus, an atmospheric plasma applicator, a flame plasma applicator, a chemical plasma applicator, etc. The corona treatment apparatus may be designed to generate a corona discharge plasma and may include a power generator, a transformer, a stationary electrode, and/or a treater ground roll, for instance. Further in other examples, the plasma applicator 112 may be configured to apply plasma in jets onto targeted objects. For instance, the plasma applicator may be designed to generate an atmospheric pressure plasma jet. It will be appreciated that when the plasma applicator is designed for plasma jetting more geometrically complex objects may be treated with plasma. Specifically, the plasma applicator may apply linear-field jets, cross-field jets, and/or end-field jets, in some embodiments.

The plasma applicator 112 includes an outlet 118. The outlet shown in FIG. 1 is an elongated slot enabling plasma to be dispensed across a width 120 of the object 104. The application of plasma in this manner may be referred to as a “waterfall” plasma treatment. However, in other examples, as discussed above the plasma may be applied in jets. In one example, the plasma may be applied with a selected speed and intensity. In one example, the height of outlet 118 of the plasma applicator 112 above the upper surface of the object 104 may correspond to the intensity of the plasma. Thus, the height of the outlet 118 of the plasma applicator may be varied to adjust plasma intensity. In other examples, the plasma applicator 112 may include a nozzle which travels back and forth across the width of the object to apply plasma to desired locations on the surface of the object. Continuing with such an example, the plasma applicator 112 may travel back and forth across the object while the height of the applicator is varied based on three-dimensional contours of the object. In this way, the plasma applicator may be designed for three-dimensional plasma treatment. In other examples, the plasma application may apply plasma to selected regions of the object while allowing other regions of the object to remain untreated with regard to plasma. For instance, a region of a footwear upper slated for attachment to a sole may be treated with plasma while the remainder of the upper may remain untreated. Thus in one use-case, a region of the object position laterally between peripheral untreated regions may be treated with plasma. However, other suitable shapes, layouts, etc., of the regions treated with plasma have been envisioned. For instance, the object may be treated with plasma in discrete sections spaced away from one another. For instance, regions slated to be coupled to toe and heel sections of a footwear sole may be treated with plasma. It will be appreciated that treating selected sections of the object with plasma may be particularly useful when the plasma treatment interferes with the waterproofness of the object, for instance.

The plasma applicator 112, in some examples, may have one or more nozzles. The nozzles may be designed with desired outlet angles, cross-sectional profiles, etc. For instance, the applicator's nozzle may be angled between 15 and 60 degrees, at 90 degrees, etc., in some examples. However, numerous suitable nozzle angles have been contemplated. Furthermore, the nozzle may include multiple openings which may or may not have different sizes, shapes, angles, etc., in some embodiments.

Additionally, the plasma applicator 112 may be designed to apply plasma at a desired power, power ranges, etc. An actuator in the applicator may be used to allow for the application of plasma at different powers. For example, the plasma may be applied at power between 400-900 watts. Power ranges such as 300-1000 watts, 450-850 watts, and 500-600 watts have been contemplated. The inventors have found, in some instances, that the benefits of plasma treating the leather object may be achieved when the plasma is applied in the abovementioned ranges. Therefore, it will be understood that, in these instances, the object may not be sensitive to small changes in the power of the plasma, allowing a less precise treatment process to be used to decrease manufacturing costs, if desired. However, narrower plasma treatment power ranges may be used. Further in one example, the plasma applicator 112 may be designed to apply plasma as a percentage of an upper threshold of the plasma output of the applicator. For example, the plasma may be applied in a range between 10% and 90% of the plasma applicator's maximum output. In other examples, the range may between 25% and 75% of maximum output. In another example, the range may be between 40% and 60% of maximum output. It was unexpectedly found that by applying plasma to the surface of the object 104 including a leather material (e.g., natural leather, synthetic leather, recycled leather, etc.,) the physical and mechanical properties of the object are improved. It was previously thought that the application of plasma onto leather might damage the leather, prior to the conception of the plasma treatment system and method, described herein. Specifically, the ply adhesion between a polymer coating and the object may be improved when the object is treated with plasma. Consequently, the object's tear and abrasion resistance will increase along with break/pipiness, etc., resulting in increased product durability and longevity. As described herein a break/pipiness scale measures the wrinkling of the grain of natural leather or the top surface of a synthetic material when folded inwards to a predetermined curvature. Moreover, the aforementioned benefits may be leveraged to increase the manufacturing efficiency of the object and reduce the environmental footprint of the manufacturing process. For instance, the increased ply adhesion between the surface of the object and the polymeric coating may allow a step of buffing the polymeric coating to be omitted during manufacturing, if desired. Additionally, due to the increased tear strength of object reinforcing material in consumer goods using the object may be reduced in size or omitted, if desired, to further decrease manufacturing costs. In one example, the plasma may interfere with waterproof treatment in the leather object. Therefore, in such an example, the plasma treatment may be carried out on regions of the object that will not form an external surface of the good (e.g., article of footwear) in which the object is incorporated and/or in other regions where waterproofing is not desired. In this way, the plasma treatment may be selectively applied to reduce the treatment's impact on the waterproofing of the consumer good.

The adhesive applicator 114 is designed to apply a layer of adhesive onto the plasma treated object. The layer of adhesive may include an adhesive cement and/or may or may not include PU, in some examples. It will be appreciated that due to changes in the properties of the object caused by the plasma treatment, the adhesive cement may provide increased bonding strength between the object and the coating that was not previously possible. Additionally, using an adhesive without PU, such as adhesive cement, decreases the environmental and health impacts of the adhesive. The layer of adhesive may additionally or alternatively include thermoplastic polyurethane (TPU) based adhesives, ethylene vinyl acetate (EVA) based adhesives, acryl based adhesive, polyolefin based adhesives, polyester based adhesives, cyanoacrylate based adhesives, combinations of the aforementioned adhesives, and/or other suitable types of adhesives. Example adhesive applicators include a spray applicator with a nozzle, a brush applicator, a roller applicator, etc. The adhesive applicator 114 is designed to apply a width of adhesive to the object 104 as it travels down the conveyor 108. Specifically, in one example, the adhesive applicator 114 may apply adhesive to regions of the object which have been plasma treated.

The coating applicator 116 is configured to bond a polymeric coating onto the plasma treated object 104 after the layer of adhesive is applied. The polymeric coating may include a film, a dye, a wax, an oil, a paint, a print material, and/or PU. Example polymeric coating applicators include a lamination device, a spray applicator, a brush application, a roller applicator, a drip applicator, etc. The polymeric coating provides abrasion resistance and has increased adhesion with the outer surface of the object 104 due to the plasma treatment when compared to objects that have not been treated with plasma.

Sensors 122 may also provide signals to a controller 124 included in the plasma treatment system 100. The sensors may include temperature sensors, pressure sensors, etc. The sensors may be integrated into one or more of the applicators in the plasma treatment system 100 or each of the applicators may include similar sensors. For instance, the plasma applicator 112 may include a temperature sensor and/or a pressure sensor enabling the applicator to achieve target set-points. The sensors also may include an adhesive flowrate sensor detecting the flowrate of the adhesive from the adhesive applicator.

The controller 124 also sends and receives signals from the camera 102, the plasma applicator 112, the adhesive applicator 114, and the coating applicator 116. The controller 124 also receives signals from the sensors 122 and includes memory 126 which stores instructions executable by a processor 128. The instructions may include the plasma treatment methods, processes, techniques, etc., described herein. For instance, in one example, the controller 124 may include code stored in memory 126 executable by the processor 128 to operate of the plasma applicator to direct plasma onto an object to form a plasma treated leather object. Further, the controller 124 may send command signals to the plasma application that trigger actuators in the applicator which initiate plasma generation. The controller 124 may also include code stored in memory 126 executable by the processor 128 to operate the adhesive applicator to apply adhesive to the plasma treated leather object. The controller 124 may also include code stored in memory 126 executable by the processor 128 to operate the coating applicator to bond a polymeric coating to the plasma treated leather object after the adhesive is applied. In this way, the object may be treated with plasma and then adhesively bonded with a polymeric coating protecting the object from abrasion, water damage, etc.

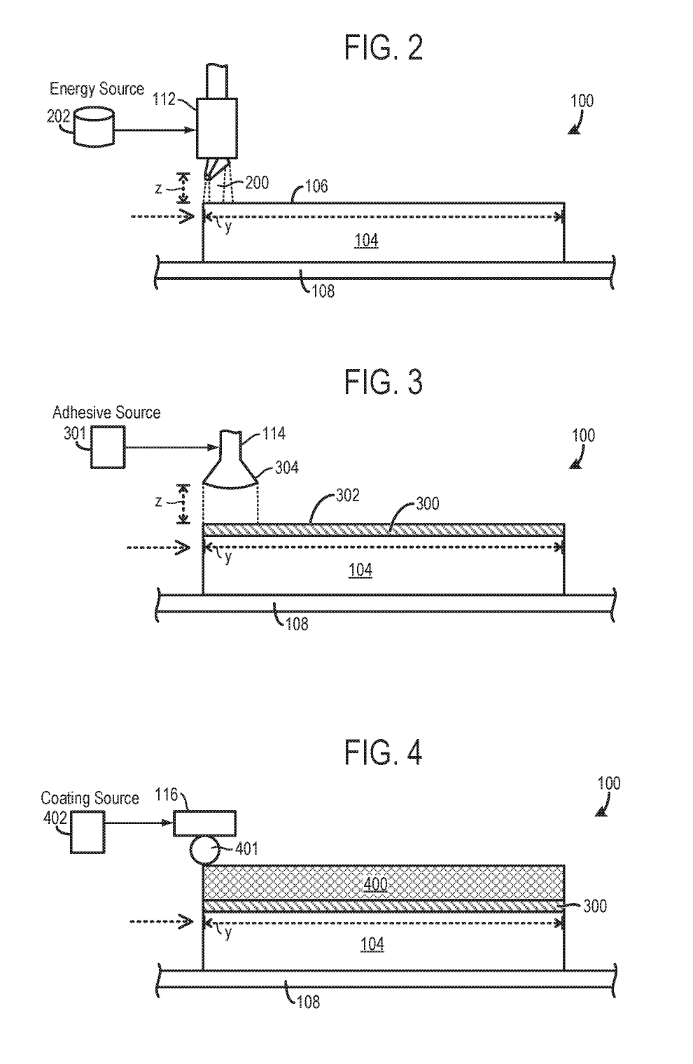

FIGS. 2-4 show a detailed view of sequentially executed steps in a plasma treatment process using the plasma treatment system 100, shown in FIG. 1. Turning specifically to FIG. 2 which illustrates the application of plasma 200 onto the object 104 from the plasma applicator 112. The conveyor 108 is shown moving the object 104 in a direction along the y-axis. Furthermore, the plasma applicator 112 is positioned at a height ‘z’ from the upper surface 106 of the object 104. An energy source 202 is shown providing energy to the plasma applicator 112 to enable the applicator to generate plasma. The plasma applicator dispenses plasma across the width of the object. The width of the object extends into and out of the page in the perspective shown in FIG. 2, along an x-axis. When the plasma is applied in this manner the efficiency of the plasma applicator is increased because arms, carriages, or other suitable devices designed to laterally move the outlet of the plasma applicator may be excluded from the system or shut down to conserve energy, if desired. As previously discussed, the plasma applicator 112 may treat selected sections of the object 104 with plasma, in some examples.

FIG. 3 shows the application of an adhesive layer 300 onto the plasma treated object 104 via the adhesive applicator 114. An adhesive source 301 is shown providing adhesive to the adhesive applicator. It will be appreciated that the adhesive may be a solid or liquid adhesive. The conveyor 108 moves the object 104 in a direction along the y-axis. The adhesive applicator 114 is positioned at a height z from the surface 302 of the adhesive layer 300. The adhesive applicator 114 includes a nozzle 304 spraying adhesive therefrom in a direction towards the object. In one example, the nozzle may be designed to direct adhesive across the width of the object, similar to the plasma applicator. In other examples, the nozzle may be designed to spray adhesive onto selected sections of the object. For instance, the adhesive may only be applied to plasma treated sections of the object. However, as previously discussed the adhesive applicator 114 may be a brush applicator or a roller applicator. In such an example, the brush or roller may be in contact with the plasma treated object to enable adhesive to be wiped onto the plasma treated object. The adhesive applicator 114 may also include heaters, fans, and/or other suitable devices for curing the adhesive, in some examples.

FIG. 4 shows the bonding between a polymeric coating 400 and the plasma treated object 104 via the adhesive layer 300 using the coating applicator 116. The object 104 is again shown traveling along the conveyor 108 in a direction along the y-axis. The coating applicator 116 may include a roller 401 or a plurality of rollers for applying the polymeric coating 400 onto the layer of adhesive 300 to bond the polymeric coating 400 to the underlying object 104. In such an example, the polymeric coating may be in the form of a sheet. However, numerous suitable coating applicators have been contemplated. Additionally, a coating source 402 is also shown in FIG. 4 providing a polymeric coating to the coating applicator 116. The coating source may be a polymer sheet or may take the form of a device storing a liquid polymer. Treating the object with plasma and then applying a polymeric coating to the object increases ply adhesion between the polymer and the object. In particular, when the plasma is used to treat natural leather the peel strength between the leather hide and the polymeric coating is improved, thereby increasing bond score. The increase in peel strength of the leather is caused by the ability of the plasma treatment to degrease the leather. On the other hand when the plasma is used to treat synthetic leather PU substrates in the synthetic material may contain lubricants which may interact with the plasma to improve coating adhesion and peel properties of the synthetic material. Consequently, the object's durability and lifespan are increased, thereby increasing consumer appeal of products incorporating the plasma treated object.

FIG. 4 also shows the polymeric coating 400 having a greater thickness than the adhesive layer 300. However, in other examples the polymeric coating 400 may have a substantially similar thickness to the adhesive layer 300 or the adhesive layer may have a greater thickness than the polymeric coating 400.

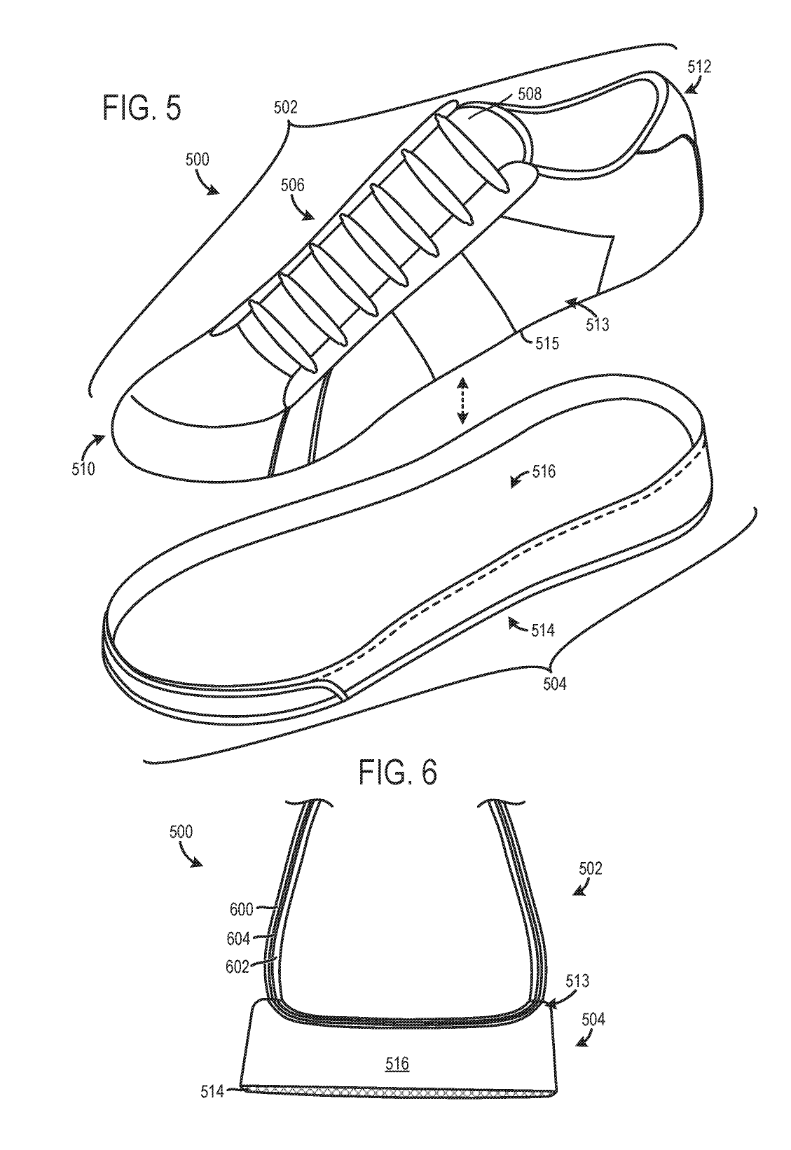

FIG. 5 shows an exploded view of an article of footwear 500 having an upper 502 and a sole 504. Therefore, the upper may be referred to as a footwear upper and the sole may be referred to as a footwear sole, in some examples. It will be appreciated that at least a portion of the upper may be treated with plasma and bonded with a polymeric coating via an adhesive, as discussed above with regard to FIGS. 1-4. The upper 502 is also at least partially constructed out of a natural and/or synthetic leather material. The upper 502 is also shown including a lacing section 506, a tongue 508, a toe section 510, and a heal section 512. However, it will be appreciated the article of footwear may include numerous additional or alternative sections. Moreover, different sections of the upper 502 may be formed from different materials. For instance, the lacing section 506 may be constructed out of a synthetic material while sections below the lacing section may be constructed out of a natural leather material. However, at least a bite line 513 and/or an underside 515 of the upper 502 may include natural and/or synthetic leather material. The different sections of the upper 502 may be attached via stitching, adhesive attachment, fabric welding, etc.

The sole 504 may include an outsole 514 which may be constructed out of a resilient material designed to contact an external surface (e.g., road, trail, floor, etc.). The resilient material may include rubber, an elastomeric material, etc. The sole 504 may also include a midsole 516 providing cushioning to the article of footwear 500. The midsole 516 may be constructed out of materials such as ethylene-vinyl acetate (EVA) foams, PU foams, etc. It will be appreciated that the sole may include other typical components such as cushioning components (e.g., airbags), protective components (e.g., plates), etc.

FIG. 6 shows a cross-sectional view of the article of footwear 500, shown in FIG. 5, in an assembled state. The upper 502 and sole 504 are again shown. The sole 504 includes the midsole 516 and an outsole 514. The upper 502 includes a polymeric coating 600 bonded to plasma treated leather 602 (e.g., natural leather or synthetic leather) via an adhesive layer 604 which may be formed via the plasma treatment process described above with regard to FIGS. 1-4. As such, the upper 502 may have greater adhesion between the polymeric coating 600 and the plasma treated leather 602 when compared to non-plasma treated uppers. Therefore, the bite line 513 may not be buffed prior to attachment between the upper 502 and the sole 504. Consequently, the manufacturing efficiency of the article of footwear is increased. Additionally, reinforcement material in the upper may also be reduced in the upper 502 in some instances, due to the increased tear resistance of the leather caused by the improved adhesion between the plasma treated leather and the polymeric layer. It will be appreciated that reinforcing material may be reduced in other sections of the article of footwear. For instance, reinforcing material may be reduced in the eyerow, top line, toebox, etc., of the article footwear. Consequently, the manufacturing cost of the article of footwear may be reduced which may in turn reduce the retail price of the article of footwear, if desired. Furthermore, the article of footwear may have localized reinforcement which may depend on the upper pattern design such as back tab or seam reinforcements, in some examples. However in other examples, the reinforcement in the upper may not be reduced to increase the durability of the article of footwear. The polymer coated leather may be adhesively bonded to the sole 504 and specifically to the midsole 516, in the illustrated example. The adhesive used to attach the upper to the sole may include adhesive cements, water-based adhesives, primers, etc. In particular, the adhesive cement may be a solvent based cement, a water based cement, or a partially solvent and partially water based cement. The primer may be a solvent based primer, a water based primer, or a partial solvent and water based primer. In one example, steps of cleaning and/or priming the upper may be avoided when attaching the upper to the sole. However, in other examples the upper may be cleaned and primed prior to or during attachment to the sole. It will be appreciated that the upper of the article of footwear shown in FIG. 6 has increased tear resistance, abrasion resistance, and break/pipiness due to the use of the plasma treated leather bonded with the polymeric coating.

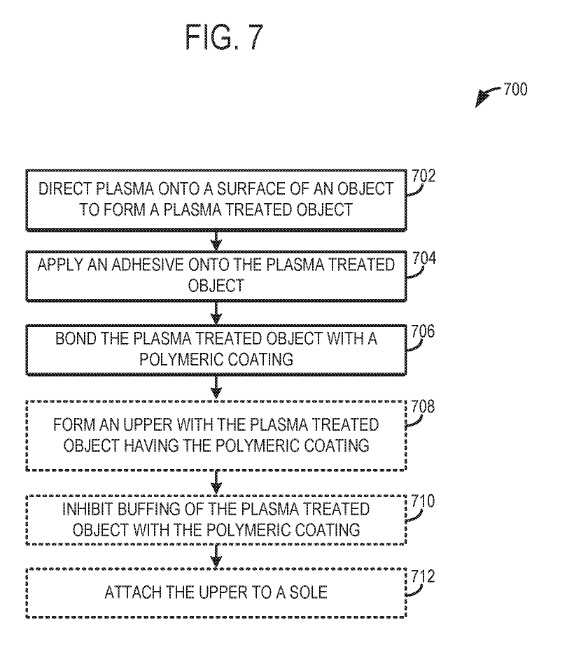

FIG. 7 shows a plasma treatment method 700. The method 700 as well as the other methods described herein may be implemented by the plasma treatment system, system components, system devices, etc., described herein with regard to FIGS. 1-4. However in other examples, the methods may be implemented by other suitable plasma treatment systems, components, devices, etc.

At 702 the method includes directing plasma onto a surface of an object to form a plasma treated object, the object including at least one of a natural leather material and a synthetic leather material. In one example, the object may include recycled leather material. It will be appreciated that the plasma treatment may increase the polarity of the outer layer of the object and decreases the number of stable bonds in the outer layer. As a result, the plasma treated surface may more easily bond with an adhesive layer and a polymeric coating applied during subsequent manufacturing steps. Specifically in one example, the surface of the untreated object includes relatively stable bonds such as C═C, C—H and other C—R bonds which may be impurities and oils. After plasma treatment the surface includes less stable bonds such as C—O, C═O, and CO—OH bonds. Specifically, the C—C/C—H peaks may drop after plasma treatment and C—O, C═O, and COOH bonds may be relatively larger after plasma treatment. The less stable bonds in the plasma treated surface are more chemically ready for covalent bonding. As such, upon the application of adhesive and a polymeric coating, the bonding between the polymeric coating and the surface is increased due to the increase in available bond sites. In this way, the ply adhesion between the polymeric coating and the surface is increased. The increased ply adhesion between the object and the polymeric coating in turn increases the object's abrasion resistance, the tear strength of the object, and the break/pipiness of the object. Consequently, the durability, longevity, and product appeal are all increased.

Next at 704 the method includes applying adhesive to the plasma treated object. As previously discussed, the adhesive may include an adhesive cement and/or PU. Specifically, in one example, the adhesive may include cement and not PU. When the adhesive is applied to the plasma treated object the bonding to the surface is increased due to the increase in bonding sites created by the plasma treatment. It will be appreciated that a step of cleaning (e.g., degreasing) the plasma treated object prior to the application of adhesive may be omitted, in one example, because of the plasma treatment cleans the surface of the object. In another example, a step of priming the plasma treated object may also be absent from the method. However, in other examples the plasma treated object may be primed prior to or during the application of adhesive.

At 706 the method includes bonding the plasma treated object with a polymeric coating. Bonding the plasma treated object with the polymeric coating may include laminating a polymeric coating onto the plasma treated object having a layer of adhesive. Additionally, the step of bonding may include drying (e.g., oven drying) the polymeric coating. Furthermore, the polymer coated object may be cured after the coating is applied, in some instances.

When the object described in method 700 is used in an article of footwear the method may include steps 708-712. However, it will be appreciated that the object may be used in other consumer goods such as sporting goods, fashion goods, furniture, etc.

At 708 the method includes forming an upper with the plasma treated object having the polymeric coating. Forming the upper with the plasma treated object may include conventional steps such as cutting plasma treated leather sheets, folding the leather sheets, stitching the folded object, adhesively bonding the folded objects, etc. However, in other examples a pre-formed upper or another three-dimensional object may be treated with the plasma, adhesive, and polymeric coating.

At 710 the method includes inhibiting buffing of the plasma treated object with the polymeric coating. For instance, the polymeric coating may remain on a bite line of the article of footwear. In this way, the buffing step can be circumvented to decrease manufacturing costs of the article of footwear. It will be appreciated that in other examples, a duration and/or intensity of a buffing step of the object may be reduced when the object is treated with plasma. In this way, the manufacturing costs of the object can be decreased, albeit to a lesser extent when compared to eliminating the buffing step. Moreover, reducing or eliminating buffing also decreases the likelihood of unintended damage to the object caused by buffing.

Next at 712 the method includes attaching (e.g., adhesively attaching) the upper to a sole. In one example, the upper may be directly attached to the sole. In such an example, the directly attachment may be accomplished without implementing any intermediary steps, such as a step of buffing the upper. Therefore in some examples, the method may include the step of inhibiting buffing and directly attaching the upper to the sole. However, in other examples the step of inhibiting buffing may be omitted from the method and the method may include directly attaching the upper to the sole. In one example, the upper may be attached (e.g., directly attached) to a midsole or an outsole. In another example, the upper may be attached to a single sole unit. Suitable adhesives attaching the upper to the sole may include adhesive cements (e.g., water based cements and/or solvent based cements), primers (e.g., water based and/or solvent based primers, etc. In one example, priming may be omitted from step 712 while in other examples step 712 may include priming. Method 700 enables the polymeric coating to strongly adhere to the plasma treated object to achieve the previously mentioned benefits of increased ply adhesion, abrasion resistance, tear strength, and break/pipiness, thereby increasing the durability and longevity of the object.

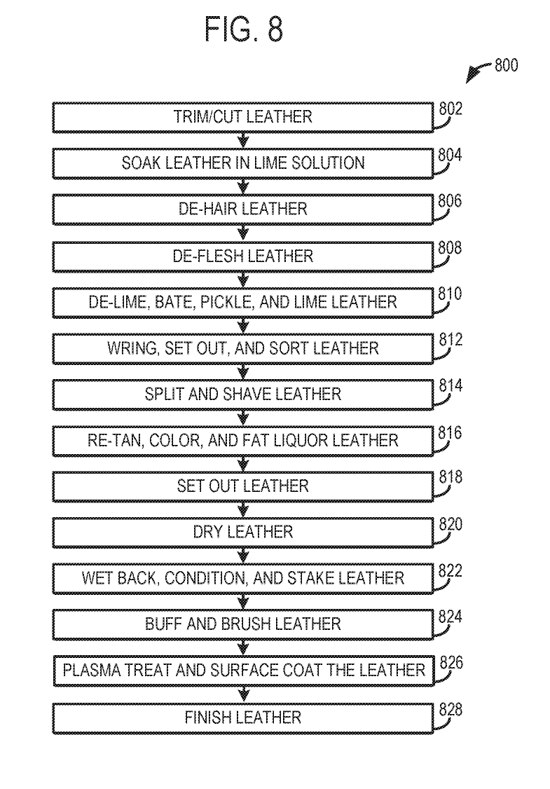

FIG. 8 shows an example use-case leather treatment method 800 related to a natural leather material. It will be appreciated that method 800 is provided as one potential use-case in which the plasma treatment process is incorporated. However, the plasma treatment method described herein may be incorporated into numerous alternative leather treatment processes that include additional or alternative steps and/or alternate step sequencing. Moreover, synthetic leather processes have also been considered.

At 802 the method includes trimming and cutting a natural leather object. For instance, a hide may be cut into desired pattern. Next at 804 the method includes soaking the leather object in a lime solution or other suitable alkaline solution. The liming may be performed using a drum, paddle, a pit, etc. Liming the leather enables natural grease and fats to be removed from the leather, removes keratin proteins, and removes collagen fibers.

At 806 the method includes de-hairing the leather object and at 808 the method includes de-fleshing the leather object. Next at 810 the method includes de-liming, bating, pickling, and liming the leather object. De-liming removes liming and de-hairing chemicals from the pelt. Additionally, pickling removes proteins from the pelt for softening. Next at 812 the method includes wringing, setting out, and sorting the leather. At 814 the method includes splitting and shaving the leather. Next at 816 the method includes re-tanning, coloring, and fat liquoring the leather. Fat liquoring the leather includes the introduction of oil into the leather to soften the leather.

At 818 the method includes setting out the leather and at 820 the method include drying the leather. Next at 822 the method includes wet backing, conditioning, and staking the leather. Staking may include applying pressure to selected areas of the leather for additional softening.

At 824 the method includes buffing and brushing the leather. At 826 the method includes plasma treating and surface coating the leather. Such plasma treating may be implemented via the plasma treatment steps, adhesive application steps, and polymeric coating steps described herein such as steps 702-706, shown in FIG. 7.

At 828 the method includes finishing the leather. The finishing application can vary between brush, spray, roller coating, film lamination, flow coating, etc. Method 800 enables the plasma treatment process to be incorporated at a late stage in the leather manufacturing process. Specifically, the plasma treatment step may be implemented subsequent to the steps of tanning, conditioning, and/or buffing the leather object. Consequently, the plasma treatment process may not be overly disruptive to the leather treatment method. Therefore, the plasma treatment process may be efficiently incorporated into a leather treatment process, reducing manufacturing costs while increasing ply adhesion of the leather with surface coatings. The limited disruption of the leather treatment method may results in a decrease in the cost of plasma treating the leather object. However, the plasma treatment process may occur during different stages of leather manufacturing, in other examples. Moreover, the plasma treatment process may also be utilized in recycled and/or synthetic leather manufacturing processes.

The invention will further be described in the following paragraphs. In one aspect, a plasma treatment method is provided that includes directing plasma onto a surface of an object to form a plasma treated object, the object including at least one of a natural leather material and a synthetic leather material, applying adhesive onto the plasma treated object, and bonding the plasma treated object with a polymeric coating.

In another aspect, a plasma treatment system is provided that includes a plasma source, an adhesive applicator, a coating applicator, and a controller including instructions stored in memory executable by a processor to operate the plasma source to direct plasma onto an object to form a plasma treated object, the object including at least one of a natural leather material and a synthetic leather material, operate the adhesive applicator to apply adhesive to the plasma treated object, and operate the coating applicator to bond a polymeric coating to the plasma treated object.

In another aspect, an article of footwear is provided that includes an upper including a plasma treated layer having a polymeric coating, the plasma treated layer including at least one of a natural leather material and a synthetic leather material, and a sole adhesively attached to the plasma treated layer with the polymeric coating.

In yet another aspect, a method for treating an article of footwear with plasma including directing plasma from a plasma source onto a surface of an object to form a plasma treated object having an increased polarity and destabilized bonds, the object including at least one of a natural leather material and a synthetic leather material, applying an adhesive layer to the plasma treated object, bonding the plasma treated object with a polymeric coating, forming an upper with the plasma treated object, and attaching the upper to a sole. The method may further include inhibiting buffing of the plasma treated object with the polymeric coating prior to the attachment of the upper to the sole.

In another aspect, a plasma treatment method is provided that includes directing plasma from a plasma applicator onto a surface of a leather object to form a plasma treated leather object having an increased polarity and destabilized bonds, applying an adhesive layer to the plasma treated object, and bonding the plasma treated object with a polyurethane (PU) coating.

In any of the aspects or combinations of the aspects, the object may be included in a footwear upper and the method may further comprise directly attaching the upper to at least a portion of a footwear sole.

In any of the aspects or combinations of the aspects, the object may be included in an upper and the method may further comprise adhesively attaching the upper to the sole without buffing the polymeric coating in the upper.

In any of the aspects or combinations of the aspects, the polymeric coating may include polyurethane (PU).

In any of the aspects or combinations of the aspects, the natural leather material may include recycled leather fibers.

In any of the aspects or combinations of the aspects, the polymeric coating may include one or more of a film, a dye, a wax, an oil, a paint, and a print material.

In any of the aspects or combinations of the aspects, a polarity of the plasma treated object may be greater than a polarity of the object prior to plasma treatment.

In any of the aspects or combinations of the aspects, the plasma treated object may have fewer stable bonds than the object prior to plasma treatment.

In any of the aspects or combinations of the aspects, the adhesive may include an adhesive cement and does not include PU.

In any of the aspects or combinations of the aspects, applying the plasma may include applying the plasma at a selected speed and intensity.

In any of the aspects or combinations of the aspects, applying the plasma may include directing plasma across a width of the surface of the object.

In any of the aspects or combinations of the aspects, the object may be included in an upper and where the controller may further include instructions stored in memory executable by the processor to adhesively attach the upper to a sole without buffing the upper.

In any of the aspects or combinations of the aspects, the object is included in an upper and where the controller further includes instructions stored in memory executable by the processor to directly attach the upper to a sole.

In any of the aspects or combinations of the aspects, the upper may be directly attached to the sole.

In any of the aspects or combinations of the aspects, the upper may be directly attached to the sole without buffing the polymeric coating in the upper.

In any of the aspects or combinations of the aspects, the plasma treated leather object may be an upper in an article of footwear and where the method may further include directly adhesively attaching the upper to a sole.

In any of the aspects or combinations of the aspects, the adhesive may include an adhesive cement.

In any of the aspects or combinations of the aspects described herein, the polymeric coating may not buffed prior to attachment to the midsole.

In any of the aspects or combinations of the aspects, the plasma treatment method may further include, subsequent to bonding the polymeric coating onto the plasma treated object, inhibiting buffing of the plasma treated object with the polymeric coating, where the plasma treated object having the polymeric coating is directly bonded to the upper.

In any of the aspects or combinations of the aspects, the object may include only the natural leather material and the step of directing plasma onto the surface of the object may be implemented after tanning, conditioning, and/or buffing the natural leather material.

Note that the example control and estimation routines included herein can be used with various fastener system configurations. The control methods and routines disclosed herein may be stored as executable instructions in non-transitory memory and may be carried out by a plasma treatment system.

The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in a plasma treatment system, where the described actions are carried out by executing the instructions in the plasma treatment system including the various components.

It will be appreciated that the configurations and routines disclosed herein are exemplary in nature, and that these specific embodiments are not to be considered in a limiting sense, because numerous variations are possible. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A plasma treatment method comprising:
directing plasma onto a surface of an object to form a plasma treated object, the object including at least one or more of a natural leather material and a synthetic leather material;
applying adhesive onto the plasma treated object; and
bonding the plasma treated object with a polymeric coating.

2. The plasma treatment method of claim 1, where the object is included in a footwear upper and the method further comprises directly attaching the upper to at least a portion of a footwear sole.

3. The plasma treatment method of claim 2, further comprising, subsequent to bonding the polymeric coating onto the plasma treated object, inhibiting buffing of the plasma treated object with the polymeric coating, where the plasma treated object having the polymeric coating is directly bonded to the upper.

4. The plasma treatment method of claim 1, where the object includes only the natural leather material and where the step of directing plasma onto the surface of the object is implemented after tanning, conditioning, and/or buffing the natural leather material.

5. The plasma treatment method of claim 1, where the adhesive includes an adhesive cement and does not include PU.

6. The plasma treatment method of claim 1, where applying the plasma includes directing plasma across a targeted portion of a width of the surface of the object.

7. The plasma treatment method of claim 1, where the polymeric coating includes polyurethane (PU).

8. The plasma treatment method of claim 1, where the natural leather material includes recycled leather fibers.

9. The plasma treatment method of claim 1, where the polymeric coating includes one or more of a film, a dye, a wax, an oil, a paint, and a print material.

10. The plasma treatment method of claim 1, where a polarity of the plasma treated object is greater than a polarity of the object prior to plasma treatment and/or the plasma treated object has fewer stable bonds than the object prior to plasma treatment.

11. A plasma treatment system comprising:
a plasma source;
an adhesive applicator;
a coating applicator; and
a controller including instructions stored in memory executable by a processor to:
operate the plasma source to direct plasma onto an object to form a plasma treated object, the object including at least one or more of a natural leather material and a synthetic leather material;
operate the adhesive applicator to apply adhesive to the plasma treated object; and
operate the coating applicator to bond a polymeric coating to the plasma treated object.

12. The plasma treatment system of claim 11, where the natural leather material includes recycled leather fibers.

13. The plasma treatment system of claim 11, where the polymeric coating includes one or more of a film, a dye, a wax, an oil, a paint, and a print material.

14. The plasma treatment system of claim 11, where the polymeric coating includes polyurethane (PU) and where the adhesive includes an adhesive cement.

15. The plasma treatment system of claim 11, where the object is included in a footwear upper and where the controller further includes instructions stored in memory executable by the processor to directly attach the footwear upper to a sole without buffing the footwear upper.

16. An article of footwear comprising:
an upper including a plasma treated layer having a polymeric coating, the plasma treated layer including at least one of a natural leather material and a synthetic leather material; and
a sole attached to the plasma treated layer with the polymeric coating.

17. The article of footwear of claim 16, where the polymeric coating includes one or more of a film, a dye, a wax, an oil, a paint, a print material, and a polyurethane (PU) material.

18. The article of footwear of claim 16, where the adhesive includes an adhesive cement.

19. The article of footwear claim 16, where the natural leather material includes recycled leather fibers.

20. The article of footwear of claim 16, where upper is directly attached to the sole without buffing the polymeric coating in the upper.
